(19) United States
(12) Patent Application Publication
(10) Pub. No.: US 2013/0235563 A1
(43) Pub. Date: Sep. 12, 2013

(54) CHRISTMAS TREE SKIRT WITH LIGHTS

(71) Applicant: Denise Roos, Port St. Lucie, FL (US)

(72) Inventor: Denise Roos, Port St. Lucie, FL (US)

(21) Appl. No.: 13/798,054

(22) Filed: Mar. 12, 2013

Related U.S. Application Data
(60) Provisional application No. 61/609,761, filed on Mar. 12, 2012.

(51) Int. Cl. F21V 33/00

(52) U.S. Cl. CPC F21V 33/0028
USPC 362/122

(57) ABSTRACT

A lighted Christmas tree skirt can be formed in various sizes and can include attached garland and lights. The tree skirt can complete and finish the Christmas tree decoration process down to the floor with garland and lights. The garland on the tree skirt can be chosen to match that used for the tree. Additionally, the lights of the tree skirt can be chosen to match the lights used for the tree. Typically, the lights are garland are wrapped about an outer perimeter of the tree skirt, providing room on top of the base fabric of the tree skirt for presents under the Christmas tree. A decorative ruffle can be placed around the outer perimeter of the tree skirt for a finished look.

### CROSS-REFERENCE TO RELATED APPLICATION

This application claims the benefit of priority of U.S. provisional application No. 61/609,761, filed Mar. 12, 2012, the contents of which are herein incorporated by reference.

### BACKGROUND OF THE INVENTION

The present invention relates to Christmas tree skirts and, more particularly, to a Christmas tree skirt formed in different sizes with attached garland and multi-colored lights.

Christmas trees are typically decorated with garland and lights. Tree skirts are often made of a flexible fabric designed to wrap around the base of a tree. While these tree skirts are designed in various colors and patterns, and can be made from various materials, conventional Christmas tree skirts lack many decorative features and often do not match the decorations used on the Christmas tree itself.

As can be seen, there is a need for a Christmas tree skirt that has decorations similar to those used on a Christmas tree.

### SUMMARY OF THE INVENTION

In one aspect of the present invention, a tree skirt comprises a base fabric; one or more strings of lights disposed on at least an outer perimeter of the base fabric; and garland disposed about the one or more strings of lights.

In another aspect of the present invention, a tree skirt comprises a base fabric; one or more strings of lights disposed on at least an outer perimeter of the base fabric; garland disposed about the one or more strings of lights; a decorative ruffle disposed about the outer periphery of the base fabric; and a plurality of attachment loops connecting the one or more strings of lights and the garland to the base fabric.

These and other features, aspects and advantages of the present invention will become better understood with reference to the following drawings, description and claims.

### BRIEF DESCRIPTION OF THE DRAWINGS

FIG. 1 is a perspective view of a Christmas tree having a tree skirt wrapped therearound according to an exemplary embodiment of the present invention;

FIG. 2 is an exploded perspective view of the tree skirt of FIG. 1;

FIG. 3 is a cross-sectional view taken along line 3-3 of FIG. 1;

FIG. 4 is a cross-sectional view taken along line 4-4 of FIG. 3

FIG. 5 is a top view of the tree skirt of FIG. 1; and

FIG. 6 is a perspective view of a Christmas tree having a tree skirt wrapped therearound according to another exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a lighted Christmas tree skirt that can be formed in various shapes and sizes and can include attached garland and lights. The tree skirt can complete and finish the Christmas tree decoration process down to the floor with garland and lights. The garland on the tree skirt can be chosen to match that used for the tree. Additionally, the lights of the tree skirt can be chosen to match the lights used for the tree. Typically, the lights are garland are wrapped about an outer perimeter of the tree skirt, providing room on top of the base fabric of the tree skirt for presents under the Christmas tree. A decorative ruffle can be placed around the outer perimeter of the tree skirt for a finished look.

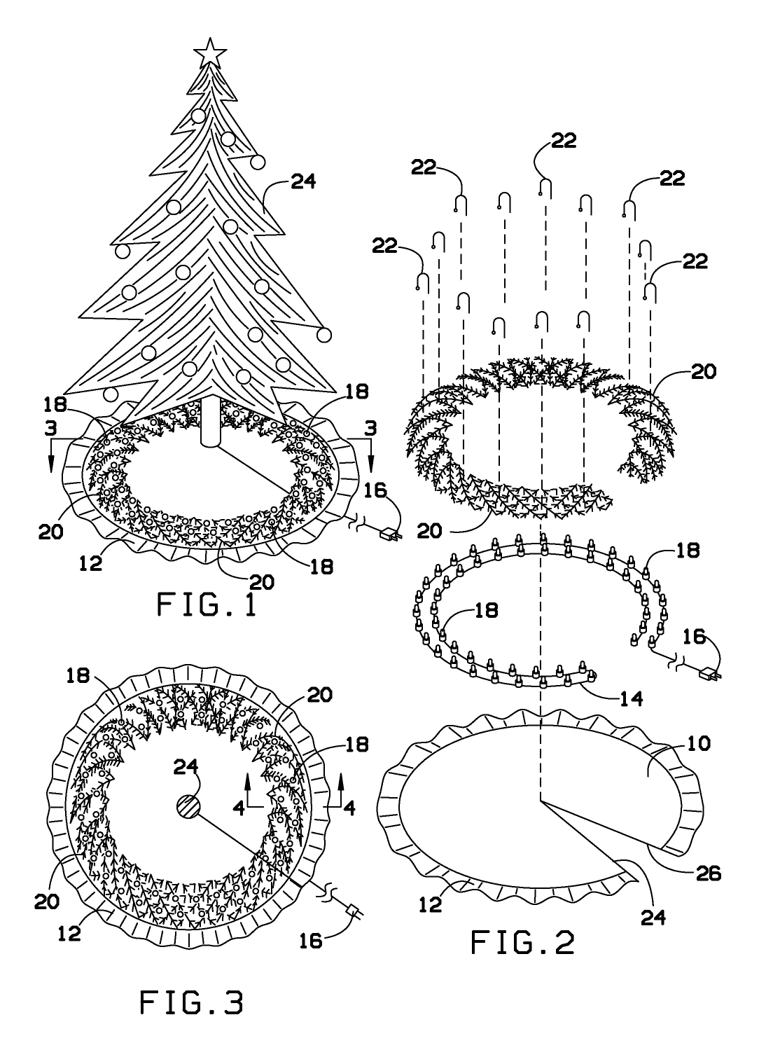

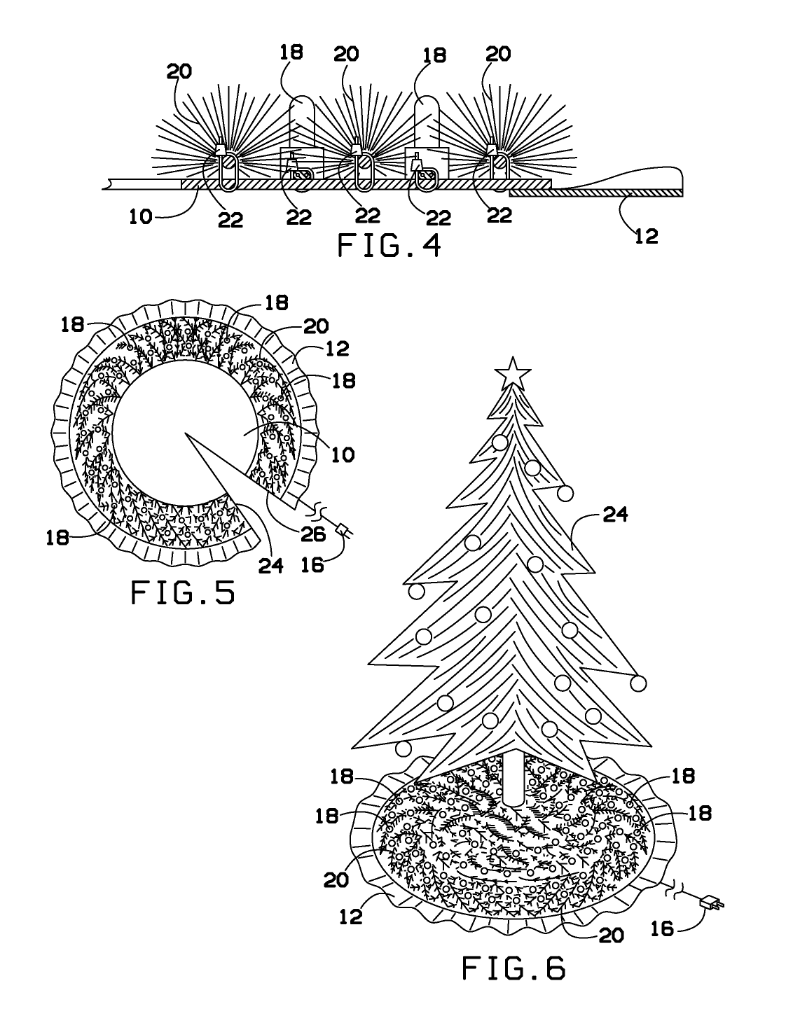

Referring now to FIGS. 1 through 5, a tree skirt can be designed to be placed around the base of a Christmas tree 28. The tree skirt can include a base fabric 10 having a slit cut half way through to form a first end 24 and a second end 26 of the base fabric 10. A decorative ruffle 12 can be attached about an outer periphery of the base fabric 10. The base fabric 10 and the decorative ruffle 12 can be formed of various materials and can include various designs and colors. In some embodiments, the base fabric 10 is a felt material.

The tree skirt can include one or more strings 14 of lights 18. The string 14 can include an electric plug 16 for powering the lights 18. In some embodiments, the string 14 of lights 18 can be powered without the need for the electric plug 16, such as by batteries, for example. The lights 18 can be designed in various styles and colors. For example, the lights 18 can be solid, flash, blink, fade, or the like. The lights 18 can be all the same color or can be designed with different colors. In some embodiments, the lights 18 can be miniature lights, light emitting diodes (LEDs), or the like. In some embodiments, the lights 18 can include a shape, such as a holiday design, a sports mascot, animals, various themes, or the like. The string 14 of lights 18 can be disposed about the outer perimeter of the base fabric 10, typically leaving a space between the string 14 and the Christmas tree 24 for placement of presents.

The tree skirt can include garland 20 disposed about the lights 18. The garland 20 can be in various colors and typically can be the same style and color as that used in the Christmas tree 28 to provide a continuous and complete decoration of the Christmas tree 28 all the way to the floor. The garland 20 can be placed next to, on top of, under, or wrapped around the string 14 of lights 18.

A plurality of attachment loops 22 can be used to attach the garland and the string 14 of lights 18 to the base fabric 10. The attachment loops 22 can be designed in various designs and styles, such as, for example, a locking plastic zip-style tie. The attachment loops 22 can fit into the base fabric 10, go under a portion of the base fabric 10 and extend back up to the top of the base fabric 10 to attach to itself while securing the garland 20 and the string 14 of lights 18.

In some embodiments, the tree skirt can be completely covered with lights 18 and garland 20, as shown in FIG. 6. In this embodiment, any presents should be placed outside of the tree skirt so they do not rest on the lights or garland.

In some embodiments, the tree skirt can be provided as a kit, where the user can choose various light and garland styles. In other embodiments, the tree skirt can be provided as a completed system, ready for placement under a Christmas tree.

While the Figures show a round Christmas tree skirt, the tree skirt of the present invention can be designed in various shapes, including geometric and non-geometric shapes. The base fabric can be made in various shapes as well as the decorative ruffle. The lights and garland can also be laid out in various shapes, typically matching the shape of the tree skirt, but, in some embodiments, the lights and garland may be laid out in shapes different from the base fabric and/or the decorative ruffle.

While the description above discusses a tree skirt for Christmas trees, the tree skirt of the present invention can be used to dress various items, including other trees or items having a mounting post or stand around which one desires to add decoration. In still other embodiments, the tree skirt can be used for other applications, such as being draped around a person or some other object. In some embodiments, the tree skirt of the present invention can be sized and shaped (such as an elongated rectangular shape) as a table runner or decorative table topper.

It should be understood, of course, that the foregoing relates to exemplary embodiments of the invention and that modifications may be made without departing from the spirit and scope of the invention as set forth in the following claims.

What is claimed is:

1. A tree skirt comprising:
a base fabric;
one or more strings of lights disposed on at least an outer perimeter of the base fabric; and
garland disposed about the one or more strings of lights.

2. The tree skirt of claim 1, further comprising a decorative ruffle disposed about the outer periphery of the base fabric.

3. The tree skirt of claim 1, further comprising a plurality of attachment loops connecting the one or more strings of lights and the garland to the base fabric.

4. The tree skirt of claim 1, wherein the base fabric is a felt material.

5. The tree skirt of claim 1, wherein a portion of the base fabric is provided without lights or garland.

6. The tree skirt of claim 1, wherein an entire surface of the base fabric is provided with strings of lights and garland.

7. A tree skirt comprising:
a base fabric;
one or more strings of lights disposed on at least an outer perimeter of the base fabric;
garland disposed about the one or more strings of lights;
a decorative ruffle disposed about the outer periphery of the base fabric; and
a plurality of attachment loops connecting the one or more strings of lights and the garland to the base fabric.

8. The tree skirt of claim 7, wherein the plurality of attachment loops are zip ties.

9. The tree skirt of claim 7, wherein a portion of the base fabric is provided without lights or garland.

10. The tree skirt of claim 7, wherein an entire surface of the base fabric is provided with strings of lights and garland.
